(19) United States
(12) Patent Application Publication
(10) Pub. No.: US 2008/0214375 A1
(43) Pub. Date: Sep. 4, 2008

(54) Trash Bags With Narrowing Seals To Facilitate Gripping

(76) Inventors: Clifford H. Patridge, Newark, NY (US); William P. Belias, Pittsford, NY (US); John H. Menendez, Fairport, NY (US); Eduard Kraminker, Rochester, NY (US)

Correspondence Address: BAKER BOTTS L.L.P., 30 ROCKEFELLER PLAZA, 44th Floor, NEW YORK, NY, 10112-4498, US

(21) Appl. No.: 12/021,671

(22) Filed: Jan. 29, 2008

Related U.S. Application Data
(62) Division of application No. 11/242,659, filed on Oct. 3, 2005, now Pat. No. 7,344,309.
Application No. 11/242,659 is a continuation of application No. 10/082,011, filed on Feb. 22, 2002, now Pat. No. 6,966,697.

(51) Int. Cl. B31B 49/04; B31B 1/64; B31B 1/62; B31B 1/26; B31B 1/00; B31B 19/26; B31B 29/26

(52) U.S. Cl. 493/189; 493/243; 493/264; 493/267

(57) ABSTRACT

Methods of forming a polymeric film bag having first and second panels that are joined to each other along a pair of opposing sides and a bottom bridging the opposing sides. Each of the first and second panels have an original width. Extending inwardly from near or at one of the pair of opposing sides is a first narrowing seal. The first narrowing seal seals the first and second panels together such that a second width of the first and second panels is created that is smaller than the original widths of the first and second panels.

### CROSS REFERENCE

This Application is a continuation application of co-pending application Ser. No. 10/082,011, filed Feb. 22, 2002, the disclosure of which, in its entirety, is hereby incorporated by reference.

### FIELD OF THE INVENTION

The present invention relates generally to polymeric bags and, more particularly, to polymeric bags having a narrowing seal feature that enables the bag to fit to upper portions of various size containers when used as a liner.

### BACKGROUND OF THE INVENTION

Sealable polymeric packages, such as trash bags, are a common household item. Some bags come to the consumer in the form of a roll of interconnected bags or as pre-separated bags housed in a dispensing box. When the bags are provided in the form of a roll, one end of the bag, the bottom, is thermally sealed closed and connected to its neighboring bag along a perforated line; the other end of the bag, the open top end, is attached to its neighboring bag solely along another perforated line. In another type of bag, a polymeric sheet is folded, creating the bottom of the bag, and the sides are sealed. When the bags are pre-separated, neighboring bags are generally overlapped or interweaved in such a manner that removal of one bag from the dispensing box draws the neighboring bag toward an opening in the box.

The bags are often sized and sold to correspond to a particular size container or trashcan. Some trash bags are designed so that a user may fold a top end of the bag over the top of the trashcan, thus lining the can with the bag. With this design, a piece of trash disposed in the trashcan will fall in the bag. If the top of the trash bag does not snugly fit the top of the trashcan, problems can arise. For example, if the perimeter of the top of the trash bag is either too small or too big, the bag may slip and fall into the trashcan. This may result in the trash missing the bag, which is undesirable and may cause customer dissatisfaction during removal of the trash from the trashcan. Therefore, it is desirable that the top of the trash bag fit snugly over the top of the trashcan.

In an attempt to address this problem, trash bags are often marked by their size and/or which size trashcan the bag is intended to fit. Most bags are labeled by the lay flat (half the perimeter) size, the diameter size, or the volume of the trashcan. Many consumers do not, however, know the lay flat, diameter, or volume size of the trashcan for which they are purchasing bags. Thus, in these situations, it is not helpful to list this information on the trash bag packages. To alleviate this problem, some bags are sold with an identification as to the type of trashcan the bag fits (i.e., tall kitchen bags). There are different sizes, however, even for “tall kitchen” trashcans. Some tall kitchen trashcans have a perimeter of 48 inches, while others may only have a perimeter of 41 or 42 inches. Thus, some consumers may still purchase the wrong size trash bags even when focused on purchasing tall kitchen bags.

Some bags that address the issue of bag slippage into the trashcan add cost in both processing and materials. For example, some bags utilize elastic drawstrings to alleviate this problem. This requires that the bag must have a drawstring, however, which is more expensive to add to the bag.

Therefore, there is a need for a trash bag that can be adjustable to fit a variety of containers or trashcans while overcoming the above-described problems.

### SUMMARY OF THE INVENTION

The present invention is a polymeric film bag that includes a first panel and a second panel that are joined to each other along a pair of opposing sides and a bottom bridging the opposing sides. The first and second panels each have an original width. At least a first narrowing seal is also included in the bag and extends inwardly from near or at one of the pair of opposing sides. The first narrowing seal seals the first panel to the second panel such that a second width of the first and second panels is created that is smaller than the original widths of the first and second panels.

The above summary of the present invention is not intended to represent each embodiment or every aspect of the present invention. This is the purpose of the Figures and the detailed description which follow.

### BRIEF DESCRIPTION OF THE DRAWINGS

The foregoing and other advantages of the invention will become apparent upon reading the following detailed description and upon reference to the drawings.

FIG. 1 is a side view of a polymeric bag according to one embodiment of the present invention.

FIG. 2 is a side view of a polymeric bag according to another embodiment of the present invention.

FIG. 3 is a side view of a polymeric bag according to another embodiment of the present invention.

FIG. 4a is a cross-sectional view taken along the line 4a-4a of FIG. 1 when the bag is in an open position.

FIG. 4b is a line cross-sectional view taken along the line 4a-4a of FIG. 1 when the bag is in a folded position.

FIG. 4c is a cross-sectional view taken along the line 4c-4c of FIG. 1 when the bag is in an open position.

FIG. 4d is a line cross-sectional view taken along the line 4c-4c of FIG. 1 when the bag is in a folded position.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

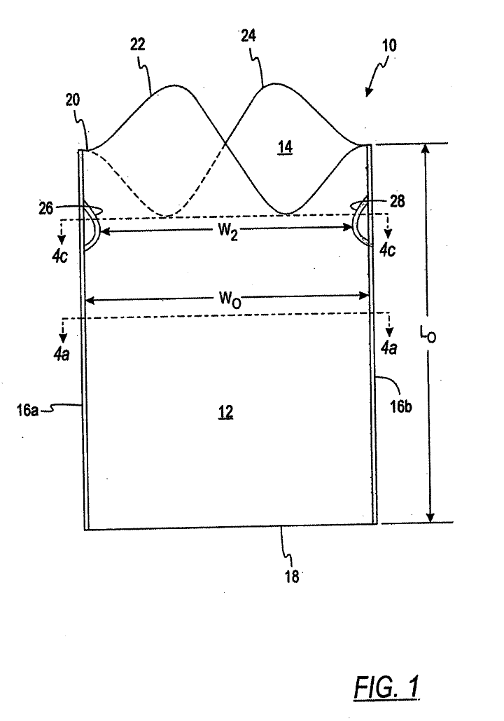

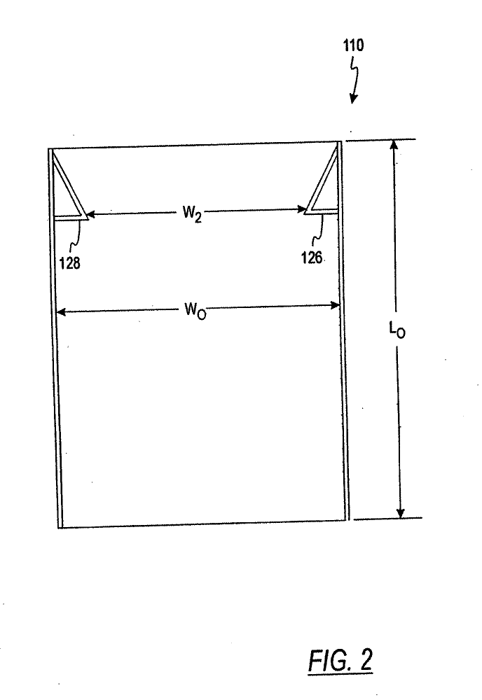

FIG. 1 illustrates a polymeric bag 10 according to one embodiment of the present invention. The polymeric bag 10 may be used in combination with a trashcan or container. The container includes a fixed shape frame and a bag engaging periphery. The polymeric bag 10 lines the trashcan or container, and a top portion of the bag engages the periphery of the trashcan or container in order to hold the bag in place. The polymeric bag 10 has a first panel 12 and a second panel 14. The first and second panels 12, 14 each have an original width and an original length. In this embodiment, the original length L₀ of the first panel 12 is about the same as the original length L₀ of the second panel 14. Similarly, the original width W₀ of the first panel 12 is about the same as the original width W₀ of the second panel 14. The first and second panels 12, 14 are joined to each other along a pair of opposing sides 16a, 16b and a bottom 18 bridging the opposing sides 16a, 16b. The first and second panels 12, 14 are open along a top end 20 formed opposite the bottom 18. The first and second panels 12, 14 may each include an optional tying flap 22, 24 at the top end 20, as shown in FIG. 1. The tying flaps 22, 24 may be used to tie the top end 20 closed after use and/or to lift the bag 10 out of the trashcan or container after use. The top end 20 of the bag 10 may also be flat (i.e., generally perpendicular to the sides), as depicted in FIG. 2. It is contemplated that the top end may be configured differently than depicted in FIGS. 1 and 2.

The first and second panels 12, 14 can be composed of a wide range of polymeric materials that have enough elasticity to expand to the original size of the bag, such as linear low density polyethylenes (LLDPE), low density polyethylenes (LDPE), high density polyethylenes (HDPE), polyesters, polystyrenes, or combinations of these polymers. Other thermoplastics may also be used to form the first and second panels 12, 14. In addition, the first and second panels 12, 14 may be composed of coextruded films having two or more layers. Each of the first and second panels 12, 14 preferably has a thickness ranging from about 0.4 mil to about 2 mils.

The first and second panels 12, 14 may be formed of one polymeric sheet of film that is folded to create the bottom 18, a first opposing side 16a, or the second opposing side 16b. The non-folded bottom 18 and/or opposing sides 16a, 16b would then be sealed, leaving the top end 20 open.

Alternatively, the first and second panels 12, 14 may be formed from two separate sheets of polymeric film that are sealed together at both of the pair of opposing sides 16a, 16b and the bottom 18. The top end 20 remains open to create the bag 10.

The first and second panels 12, 14 also include a first narrowing seal 26 and a 30 second narrowing seal 28. The first and second narrowing seals 26, 28 seal the first and second panels 12, 14 together. The first and second narrowing seals 26, 28 may be formed by heat sealing the first and second panels 12, 14 together. Alternatively, the first and second narrowing seals 26, 28 may be formed by using an adhesive to adhere the first and second panels 12, 14 together. It is contemplated that the narrowing seals 26, 28 may be formed from other methods, such as ultrasonics.

In the embodiment shown in FIG. 1, the narrowing seals 26, 28 are located below the top end 20 at or near the respective sides 16a, 16b. The narrowing seals 26, 28 initially extend inwardly from at or near the respective sides 16a, 16b, and extend generally downwardly before returning to or near the respective sides 16a, 16b. In this embodiment, the narrowing seals 26, 28 are generally arcuate in shape, however, other shapes may also be utilized. For example, bag 110 shown in FIG. 2 has narrowing seals 126, 128 that are formed in a triangular configuration. Other shapes are contemplated for the narrowing seals, such as polygonal shapes.

Returning now to FIG. 1, the narrowing seals 26, 28 create a second width W₂ that is less than the original widths W₀ of the first and second panels 12, 14. The second width W₂ enables the bag 10 to be used with containers or trashcans of multiple sizes. The top edges 20, 22 have original widths W₀, and may be placed over the tops of one size trashcan. At the narrowing seals 26, 28, however, the bag 10 has the second width W₂. The user may insert the bag 10 into a smaller trashcan, and fold the top end 20 down to the narrowing seals 26, 28. Since the narrowing seals 26, 28 create a smaller width W₂, the bag 10 can fit snugly over the top of a smaller trashcan. Thus, the present embodiment allows a single bag 10 to be used with multiple size trashcans. In one embodiment, the width W₀ of the first and second panels 12, 14 is about 24 inches and the width W₂ between the narrowing seals is about 21 inches. It is also contemplated that the original width W₀ and the second width may have other sizes to fit other size trashcans, such as outdoor trashcans. Although two narrowing seals are shown in these drawings, in some embodiments, there may only be one narrowing seal used. The narrowing seal may be located on either side of the panels and operate the same as two narrowing seals. The one narrowing seal creates the second width W₂ that is less than the original width W₀.

Thus, in these embodiments, the bag works with trashcans or containers of two different sizes, enabling consumers to purchase the bag without knowing the exact size of their container. Also, the step of adding the narrowing seals may be done with little or no increased processing time or cost, since the narrowing seals may be formed at the same time as other seals using the same machinery.

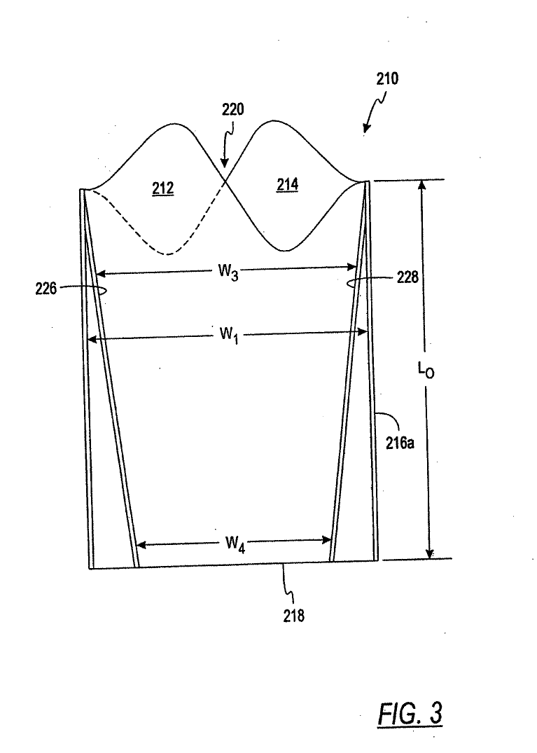

Turning now to FIG. 3, another embodiment of a trash bag 210 according to the present invention is illustrated. In this embodiment, narrowing seals 226, 228 extend toward a bottom 218 of the bag 210. The narrowing seals 226, 228 create a third width W₃ and a fourth width W₄ that are both less than an original width W₁ of first and second panels 212, 214 of the bag 210. The first and second panels 212, 214 include opposing side edges 216a, 216b, the bottom 218, and an open top end 220. The narrowing seals 226, 228 are formed to seal the first and second panels 212, 214 together, as in the embodiment discussed above. The narrowing seals 226, 228 may be joined together by hot sealing or by utilizing an adhesive.

In this embodiment, the narrowing seals 226, 228 start at or near the respective sides 216a, 216b and extend generally downwardly toward the bottom 218. In some embodiments, the narrowing seals 226, 228 extend generally parallel to the sides 216a, 216b, keeping the same width throughout. In this embodiment, the third width W₃ is approximately equal to the fourth width W₄. In the embodiment shown in FIG. 3, the narrowing seals 226, 228 extend inwardly and downwardly. Thus, the third width W₃ is greater than the fourth width W₄, and the bag 210 may be used with a variety of trashcan sizes. Also, the step of adding the narrowing seals 226, 228 may be done with little or no increased processing time or cost since the narrowing seals may be formed at the same time as other seals using the same machinery.

In some embodiments, the original widths W₁ of the first and second panels 212, 214 is approximately 24 inches and the third width W₃ is about 21 inches and decreases until the four width W₄ is about 20 inches, although other sizes are contemplated.

Although these embodiments have been described with two narrowing seals, in some embodiments, there is only one narrowing seal. The single narrowing seal operates the same as the two narrowing seals, and creates third and fourth widths W₃, W₄ that are less than the original width W₁ of the panels.

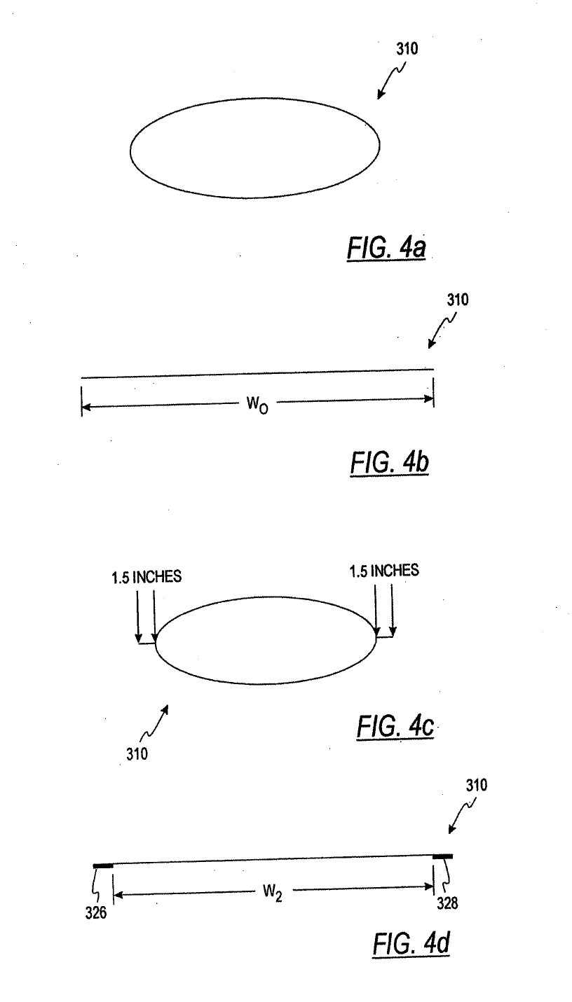

Turning to FIGS. 4a-4d, the change in diameter in a bag 310 utilizing narrowing seals 326, 328 is illustrated. FIGS. 4a and 4b show a cross-sectional view of a top end 320 of the bag 310 before the start of the narrowing seals 326, 328. FIG. 4a depicts the bag 310 in an open position, having a perimeter of about 48 inches. FIG. 4b illustrates a flat width of the bag 310, which is about 24 inches. In FIGS. 4c and 4d, cross-sectional views of the bag 310 at the narrowing seals 326, 328 are shown. At this point along the length of the bag 310, the bag 310 has a perimeter of about 42 inches and a flat width of about 21 inches. Thus, as can be clearly seen, the bag 310 can be used with at least two different size trashcans, which makes the bags easier to use and may also decrease customer dissatisfaction. Furthermore, unlike some prior attempts to solve this problem, the embodiments of the present invention do not substantially increase the material or manufacturing costs or the time in manufacturing the bag.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of forming a polymeric film bag, comprising:
providing a polymeric sheet having a length and an original width;
folding the sheet to form a first and second panel with a straight folded bottom;
joining the first and second panels to create an open top;
sealing the first and second panels to create side seals; and
forming a first narrowing seal extending inwardly and downwardly from near or at one of the side seals, the first narrowing seal disposed such that a second width of the first and second panels is created that is smaller than the original width of the polymeric sheet.

2. The method of claim 1, further comprising forming a second narrowing seal extending inwardly from near or at the other of the side seals.

3. The method of claim 2, wherein the first and second narrowing seals begin a distance from the top and extend toward the bottom.

4. The method of claim 3, wherein the first and second narrowing seals extend generally parallel to the side seals.

5. The method of claim 3, wherein the distance between the first and second narrowing seals becomes smaller towards the bottom.

6. The method of claim 2, wherein forming the first and second narrowing seals includes forming the first and second narrowing seals at the side seals, extending the narrowing seals inwardly from the side seals, and extending the narrowing seals back to the side seals.

7. The method of claim 2, wherein the narrowing seals are generally arcuate or triangular in shape.

8. A method of forming a polymeric bag, comprising:
providing first and second polymeric panels, each having a length and an original width;
sealing the first and second panels along the respective lengths and along a bottom of the first and second panels, so as to form a closed bottom, closed sides, and an open top; and
forming a first narrowing seal extending inwardly and downwardly from near or at one of the sides, the first narrowing seal disposed such that a second width of the first and second panels is created that is smaller than the original width of the first and second polymeric panels.

9. The method of claim 8, further comprising forming a second narrowing seal extending inwardly from near or at the other of the sides.

10. The method of claim 9, wherein the first and second narrowing seals begin a distance from the top and extend toward the bottom.

11. The method of claim 9, wherein the first and second narrowing seals extend generally parallel to the sides.

12. The method of claim 9, wherein the distance between the first and second narrowing seals becomes smaller towards the bottom.

13. The method of claim 9, wherein forming the first and second narrowing seals includes forming the first and second narrowing seals at the sides, extending the narrowing seals inwardly from the sides, and extending the narrowing seals back to the sides.

14. A method of forming a polymeric film bag, comprising:
providing first and second polymeric panels each having an original width and length defined between a pair of generally parallel edges,
sealing the first and second panels to form a pair of closed sides and a closed bottom, with the edge of each panel opposite the bottom remaining unsealed to define a top opening; and
forming a narrowing seal extending from each side onto adjacent portions of the first and second panels and toward the bottom, the narrowing seals disposed such that a second width between the narrowing seals is created that is smaller than the original width of the polymeric panels, the narrowing seal being disposed closer in proximity to the top of the bag than the bottom; and
folding the top opening of each panel downward in opposing directions.

15. The method of claim 14, wherein the first and second polymeric panels are formed by folding an integral polymeric sheet to form a first and second panels with a closed folded bottom.

16. The method of claim 14, wherein the first and second polymeric panels are formed by folding an integral polymeric sheet to form a first and second panel with a closed folded side.

17. The method of claim 14, wherein the first and second panels are formed from two separate polymeric sheets.

18. The method of claim 14, wherein the narrowing seals are formed by either heat sealing or adhering the first and second panels.

19. The method of claim 14, wherein the narrowing seals are formed so as to extend initially inwardly from said bag sides and extending generally downwardly before extending back to the bag sides.
